(19) United States
(12) Patent Application Publication
(10) Pub. No.: US 2003/0169825 A1
(43) Pub. Date: Sep. 11, 2003

(54) Signal processor and method for the system-independent digital generation of mobile communication transmit signals of different mobile radio standards

(76) Inventor: Dietmar Wenzel, Munchen (DE)

Correspondence Address: LERNER AND GREENBERG, P.A., POST OFFICE BOX 2480, HOLLYWOOD, FL, 33022-2480, US

(21) Appl. No.: 10/389,582

(22) Filed: Mar. 14, 2003

Related U.S. Application Data
(63) Continuation of application No. PCT/DE01/03353, filed on Aug. 28, 2001.

(30) Foreign Application Priority Data
Sep. 14, 2000 (DE) 100 45 547.6

(51) Int. Cl. H04K 1/10; H04L 27/28

(52) U.S. Cl. 375/260

(57) ABSTRACT

Mobile communication transmit signals are digitally generated for signal processing and/or D/A conversion of the transmit signals of different mobile radio standards. In the novel method only a single system-independent clock rate is generated and, accordingly, only exactly one clock frequency generator is arranged on the chip. For this purpose, the signal processing path of each mobile radio standard has at least one interpolator, particularly an asynchronous interpolator, for converting the transmit signals to a uniform time reference.

### CROSS-REFERENCE TO RELATED APPLICATION

This application is a continuation of copending International Application No. PCT/DE01/03353, filed Aug. 28, 2001, which designated the United States and which was not published in English.

### BACKGROUND OF THE INVENTION

### FIELD OF THE INVENTION

The invention generally relates to signal processors for mobile communication and to corresponding digital methods for generating mobile communication transmit signals. In particular, the invention then relates to such signal processors and methods in which mobile communication transmit signals for different mobile radio standards are generated and corresponding digital circuits are integrated in a single chip.

In the GSM standard that currently used in mobile communication, the so-called GMSK (Gaussian Minimum Shift Keying) modulation is used which uses a signal space with signal points having a phase difference of 180°. In addition, the GPRS (General Packet Radio Service) was developed in which it is possible to use higher data rates. As a further standard currently used, the TIA/EIA-136-(IS-136) standard is known in which a π/4-DQPSK-(Differential Quaternary PSK) modulation method is used for generating the transmit signals. As an intermediate standard between GSM and GPRS, on the one hand, and UMTS, on the other hand, the EDGE standard and the associated EGPRS (Enhanced GPRS) packet service was defined. Although EDGE is still a TDMA (Time Division Multiple Access) method, its modulation is already changed from GMSK to 8-PSK. In 8-PSK modulation, a signal space with 8 signal points is used and the phase difference between the individual signal points is 45°.

It is a general object to develop mobile communication devices that are designed for operation with a number of different mobile radio standards and which, accordingly, can be used in the different mobile radio systems. However, the fact that the modulation methods described above need different signal clock rates is a problem. This problem has hitherto been solved—as, for example, in the base band processors PCI 3700 and PCI 3800 for GSM and TIA/EIA-136 and for GSM, EDGE and TIA/EIA-136, respectively, by the company PrairieComm, in that a separate special signal processing architecture is used for each mobile radio standard and was supplied with a signal clock rate precisely tuned to the corresponding mobile radio standard. However, this leads to multiple circuit blocks being required for similar tasks and having to be supplied with different signal clock rates. As a rule, this leads to an increased requirement for components and for chip area. The operation with different system clock rates thus makes it more difficult to integrate the functions in one component. Due to the separate processing with different clock rates, it is also not possible, as a rule, to transfer the signals to the module for converting the low-pass signal to the carrier frequency via a uniform interface so that a number of D/A converters are required in this case.

### SUMMARY OF THE INVENTION

It is accordingly an object of the invention to provide a signal processor and a signal processing structure, respectively, and a method for the digital generation of mobile communication transmit signals, which overcome the above-mentioned disadvantages of the heretofore-known devices and methods of this general type and which enables different mobile radio standards to be supported with a reduced requirement for components and chip area on a single chip.

With the foregoing and other objects in view there is provided, in accordance with the invention, a signal processor for digitally generating mobile communication transmit signals, comprising:

a plurality of signal processing paths each for a given mobile radio standard of a plurality of mutually different mobile radio standards;

a single clock frequency generator for at least one of signal processing and D/A conversion of the transmit signals of the different mobile radio standards;

an interpolator circuit configuration connected in each the signal processing path, for converting the transmit signals to a uniform time reference;

a linear asynchronous polyphase interpolator and a polyphase determination circuit in at least one signal processing path;

the polyphase determination circuit having a phase accumulator of finite word length followed by a phase decoder for driving the interpolator and supplying the interpolator with polyphases p(n).

In accordance with an added feature of the invention, there is provided a uniform interface for transferring the transmit signals to modules for converting low-pass signals to carrier frequency.

In accordance with an additional feature of the invention, the interface contains two analog or digital signals in the form of a normal component and a quadrature component or amplitude component and phase component.

In accordance with another feature of the invention, the clock frequency generator and other signal processing circuits, such as the clock frequency generator, the interpolator circuit configuration, the linear asynchronous polyphase interpolator, and the polyphase determination circuit, are commonly integrated on a common chip.

With the above and other objects in view there is also provided, in accordance with the invention, a method for digitally generating mobile communication transmit signals compatible with a plurality of different mobile radio standards. The method comprises:

generating a common system-independent clock frequency in transmitting mode for each mobile radio standard for at least one of signal processing and D/A conversion of the transmit signals;

performing an interpolation in each signal processing path of a mobile radio standard, for converting the transmit signals to a uniform timing pattern;

processing the signals with a linear asynchronous polyphase interpolator and a polyphase determination circuit in at least one signal processing path, wherein

the polyphase determination circuit has a phase accumulator of finite word length followed by a phase decoder, and the phase decoder drives the interpolator and supplies the interpolator with the polyphases p(n).

In accordance with again an added feature of the invention, the process is utilized for mobile radio standards the include GSM, EDGE, TIA/EIA-136, and mixed forms and partial combinations of these.

In accordance with an advantageous feature of the invention, various circuit components can be jointly utilized in the signal processing path of a number of mobile radio standards. For instance, jointly utilized circuit components may include components for pulse shaping, sampling rate conversion, noise shaping, phase and frequency correction, and phase and amplitude error correction of the normal components and the quadrature components.

A primary concept of the present invention consists in generating only a single, system-independent clock rate on the chip for the signal processing and/or D/A conversion of the transmit signals of different mobile radio standards and correspondingly using only exactly one clock frequency generator.

If the time references or modulation rates provided in the mobile radio standards supported by the signal processor are different, which is mostly the case, a conversion/recalculation of the standard-specific transmit signals into a uniform time reference must then be performed. This conversion is performed by at least one interpolator such as a controllable interpolator in the signal processing path. The interpolator is, for example, an asynchronous linear interpolator which is driven, for example, by a phase accumulator.

I have previously described such a “polyphase interpolator” in the dissertation entitled “Ein digitaler Fernseh-und Tonmodulator für digitale Breitbandverteilnetze” [A digital television and sound modulator for digital broadband distribution networks] (Dietmar Wenzel), which was produced in the Institut fur Nachrichtenübertragung of Stuttgart University and published in Series 10 Information Technology/Communication of the Progress Reports under No. 617 (ISBN 3-18-361710-2) in the VDI Verlag, Düsseldorf, 1999 (called “Wenzel” hereinafter). The dissertation and particularly sections 3.3 to 3.7 (polyphase interpolator, M-tel band-pass filter, design of M-tel band-pass low-pass filters, filter structure for M-tel band-pass filters with symmetric impulse response) and sections 6.1 to 6.5 (asynchronous sampling rate conversion) and Appendix 8 are herewith incorporated by reference and the contents of the disclosure are considered a part of the present application. The asynchronous sampling rate converter developed in the paper was based on the problem that with the arrangement of television channels in frequency-division multiplex, the required bandwidth increases with increasing number of channels, and thus also the required sampling frequency. If all the individual frequency-shifted signals and signals to be transmitted are added, therefore, the sampling rate must be increased and adapted. Said interpolators were developed for this purpose. In the present application, these interpolators are used for converting the data rate of the respective mobile radio standard into a uniform time reference for all mobile radio standards with the aid of a common system clock frequency.

The interpolator exhibits a controllable interpolation ratio and its architecture is preferably of a simple structure (for example a linear interpolator), but it is still possible to use many function blocks jointly for the different signals.

At least one interpolator present in the signal processing path can be formed, for example, by a so-called FIR (Finite Impulse Response) interpolation filter. These filters can be constructed as “M-tel band-pass filters” which perform an interpolation by the factor M=L, L being the number of branches in the filter structure of the polyphase interpolator.

The invention thus avoids the necessity of the arrangement of one of a number of clock frequency generators corresponding to the number of mobile radio standards supported since the signal processing structure used in each case can be supplied with a uniform system clock. In addition, various other modules can be used jointly, for instance for sampling rate conversion, spectral noise shaping, precorrection of carrier-frequency offset, symbol phase error, I/Q phase and amplification errors, amplitude and DC component correction for all signal processing paths.

If necessary, it is also possible to use parts of the circuit sections required for the modulators such as, for example, FIR filters, for the pulse shaping.

A further advantage of the invention is that the common system clock frequency does not need to be a smallest common multiple of the respective mobile-radio-standard-specific clock frequencies or derivable from all these via rational divider factors.

Since the signals are present in a uniform time reference, only a single D/A converter is in each case needed for the I and Q component in the transmitting direction and the signals can be output to the modules for converting the low-pass signal into carrier frequency via one and the same interface. The interface can then contain two analog or digital signals in the form of a normal component and quadrature component or amplitude and phase component.

The invention can be used, in particular, for the mobile radio standards GSM, EDGE and TIA/EIA-136 or mixed forms or part-combinations of these.

Other features which are considered as characteristic for the invention are set forth in the appended claims.

Although the invention is illustrated and described herein as embodied in a method for the system-independent digital generation of mobile communication transmit signals of different mobile radio standards, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a block diagram of a signal processor according to the invention, supporting a number of mobile radio standards;

FIGS. 2A, 2B, and 2C are block schematics showing signal processing paths for the GMSK standard (A), the EDGE standard (B), and the IS-136 standard (C);

FIG. 3 is a block diagram of an end section of the signal processing path used jointly by the GMSK standard and the EDGE standard and the IS-136 standard;

FIG. 4A is a graph showing the absolute frequency response and tolerance arrangement of an 11-tel band-pass filter with 55 coefficients;

FIG. 4B is a schematic block diagram of an interpolator for non-rational sampling rate ratios with phase accumulator (B); and

FIG. 4C is a diagram of a phase decoder with 16 bits word width for 32 polyphases.

### DESCRIPTION OF THE PREFERRED EMBODIMENTS

In the exemplary embodiment, a signal processor is specified which supports the three mobile radio standards GSM, EDGE and TIA/EIA-136 and, in doing so, it has a single clock frequency generator with 104 MHz system clock frequency. The mobile radio standards operate with the following modulation methods and data rates, already mentioned initially and known per se:

| Standard | Modulation | Data rate | |
|---|---|---|---|
| GSM | GMSK | 270.83 | kbit/s |
| EDGE | 3π/8-8-PSK | 812.5 | kbit/s |
| TIA/EIA-136 | π/4-DQPSK | 48.6 | kbit/s |

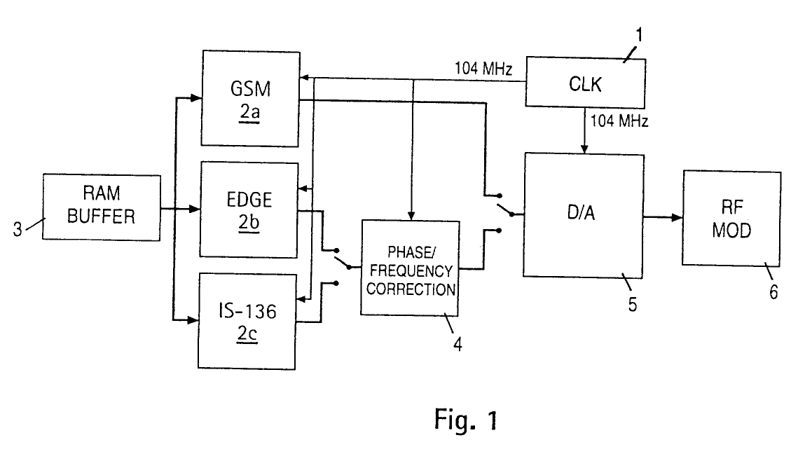

Referring now to the figures of the drawing in detail and first, particularly, to FIG. 1 thereof, the individual function blocks of the signal processor are to be operated with the uniform system clock frequency of 104 MHz, generated by a clock frequency generator 1. From a RAM buffer memory 3, the modulators 2a, 2b, 2c for the abovementioned mobile radio standards are supplied with the signal data to be modulated. While this is not specifically illustrated, it will be understood that the different modulators 2a-c, if necessary, partially use the same hardware although they have different functions. The GSM and EDGE signals are based on the same standardized time reference whereas the IS-136 standard deviates from this.

In the signal paths for the EDGE and IS-136 standard, the signals delivered by the modulators are supplied to a phase/frequency correction circuit 4 to which the system clock frequency of 104 MHz is also applied. From this circuit, the signals are then supplied to a D/A converter circuit 5. In this circuit, the spectral noise shaping, the sampling rate conversion and the precorrection of carrier frequency offset, symbol phase errors, I/Q phase and amplification errors, amplitude and DC component correction of all signal processing paths are also used jointly. Since it is not necessary to perform a phase/frequency correction in the GMSK method, the phase/frequency correction circuit 4 is not used in the GSM signal path and the signals supplied by the GSM modulator 2a are supplied directly to the D/A converter circuit 5. Following this, the low-pass signal is converted to carrier frequency in an RF modulator circuit 6 for all signal processing paths.

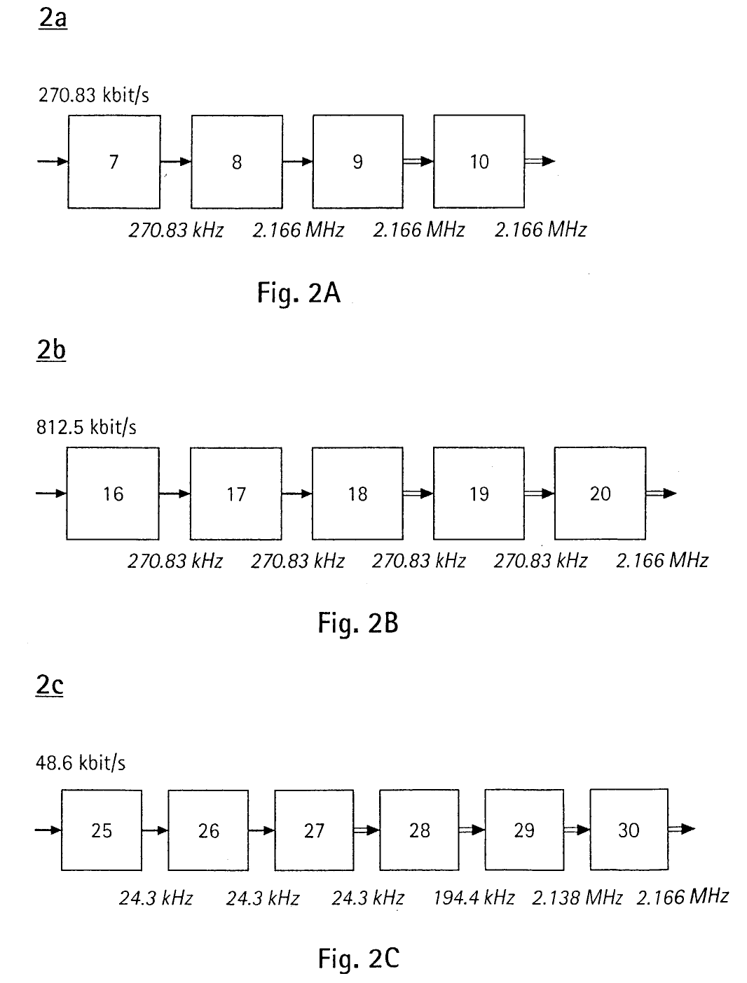

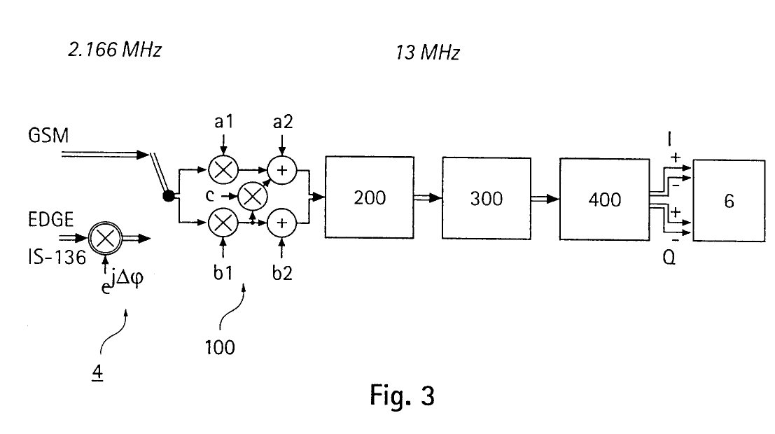

FIGS. 2A-C show the basic function blocks for the three different modulators 2A-C of FIG. 1 of the mobile radio standards. Here, FIG. 2A pertains to the GSM signal path 2a, FIG. 2B pertains to the EDGE signal path 2b, and FIG. 2C pertains to the IS-136 signal path 2c. In each case, one interpolation filter 8, 20, 28 is used for the interpolation factor 8 which, at the same time, performs the pulse shaping. All modulators shown have the common characteristic that they supply a complex digital signal with a sampling frequency of 2.166 MHz in the form of an I and Q component which is processed further with the circuit shown in FIG. 3.

For the purpose of simplification, the system clock frequency in the exemplary embodiment was selected in such a way that the “virtual” sampling frequencies shown in italics in the FIGS. can be achieved by integral division in the case of GSM and EDGE. This is not the case in the IS-136 modulator 2c which is why an additional interpolator which performs the conversion to the common time reference of 2.166 MHz is used there.

In detail, the GMSK modulator 2a has a differential coder 7, an FIR filter 8 (interpolator), a phase generation integrator 9 and an r/φ-I/Q converter 10.

The EDGE modulator 2b contains a serial/parallel converter 16 for forming groups of three bits, a symbol mapping circuit 17 in conjunction with a table memory, a symbol rotation circuit 18 for the 3π/8 rotation, a symbol generating circuit 19 in conjunction with a table memory and a pulse shaping circuit 20 in conjunction with an FIR filter (interpolator).

The IS-136 modulator 2c, in contrast, has a serial/parallel converter 25 for forming pairs of bits, a differential DQPSK coder 26, a symbol generating circuit 27 in conjunction with a table memory and a pulse shaping circuit 28 in conjunction with an FIR filter with 8-fold upward modulation. The pulse shaping circuit thus supplies an IS-136 signal with a “virtual” sampling frequency of 194.4 kHz. To be able to use as simple as possible an interpolation filter for the asynchronous interpolation to the time reference of 2.166 MHz, the IS-136 signal is first brought to a “virtual” sampling frequency of 2.138 MHz with an interpolation filter 29 with an integral interpolation factor of 11 times. For this purpose, efficient polyphase structures can be used in combination with the M-tel band-pass filters already mentioned initially.

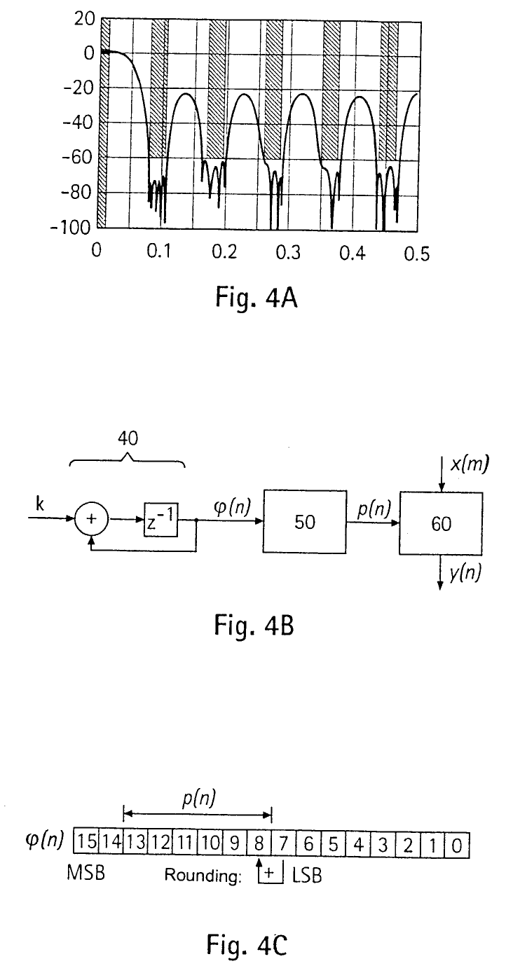

FIG. 4A shows the normalized absolute frequency response of an 11-tel band-pass filter used as interpolation filter 29 and the predetermined tolerance arrangement as an example. Due to the relatively narrow bandwidth of the IS-136 signal with approximately 30 kHz, this results in approximately 70-fold oversampling.

The asynchronous interpolator 30 following can then have correspondingly narrow stop bands which is noticed by its low number of coefficients. In the present case, the (linear) interpolator 30 has 32 polyphases and an interpolation factor of k=(13000/6)/(88×24.3)=1.0132 so that the sampling frequency can be brought from 2.138 to 2.166 MHz.

Due to the system considerations according to “Wenzel”, the polyphase number L required for the asynchronous interpolator, and thus the temporal resolution, is given by

$$L \geq \frac{{f}_{g}}{{f}_{A}} \cdot \frac{π}{\sqrt{3}} \cdot {2}^{w - \frac{1}{2}}$$

where f_{g}=15 kHz is the cut-off frequency of the IS-136 signal and f_{A}=2.138 MHz is the sampling frequency. w=11 is the effective word length in bits required for the output signal. For the parameter selected, L≈18 is obtained.

According to “Wenzel”, the signal/noise power ratio resulting from the finite stop-band attenuation of the interpolation filter can be estimated by the relation

$$S \text{/} N \approx 2 {f}_{g} \cdot {( {\sum }_{i = 1}^{L - 2} {\int }_{{if}_{A} - {f}_{g}}^{{if}_{A} + {f}_{g}} \vert H ( f ) {\vert}^{2} ⅆ f )}^{- 1}$$

where H(f) is the transfer function of the interpolation filter. For the parameter selected, a signal/noise power ratio which is adequate for the IS-136 system can already be achieved with a linear interpolator according to

y(n)=(1−p(n))·x(m−1)+p(n)·x(m)

In a circuit with an interpolator 60, the weight or polyphase p(n), respectively, can be efficiently determined by a phase accumulator 40 of finite word length followed by the phase decoder 50 according to FIG. 4B.

FIG. 4C shows as an example a phase decoder which allows the sampling frequency ratio to be set with a resolution of 16 bits and to drive an interpolator with 32 polyphases. In the case of a linear interpolator, the polyphase p(n) is interpreted as a positive twos complement number and is thus located within the interval [0;1].

A further diagrammatic block diagram in FIG. 3 illustrates how, according to the invention, function blocks for the signal processing path of the three mobile radio standards can be jointly used as has already been indicated in FIG. 1. The signals which, according to the invention, have been brought to the 2.166 MHz time reference are first supplied to an offset compensation circuit 100 in which an offset, an amplitude error or an imbalance between the I and Q component is compensated for. In a subsequent interpolator and noise shaping circuit 200 in which the interpolator has an interpolation factor of 6, the sampling frequency of 2.166 MHz is converted to 13 MHz. The signals are then supplied to a digital/analog converter 300 and then transferred to a construction filter circuit 400. As already shown in FIG. 1, finally, the modulation to the carrier frequency is performed with an RF modulator 6.

I claim:

1. A signal processor for digitally generating mobile communication transmit signals, comprising:
a plurality of signal processing paths each for a given mobile radio standard of a plurality of mutually different mobile radio standards;
a single clock frequency generator for at least one of signal processing and D/A conversion of the transmit signals of the different mobile radio standards;
an interpolator circuit configuration connected in each said signal processing path, for converting the transmit signals to a uniform time reference;
a linear asynchronous polyphase interpolator and a polyphase determination circuit in at least one signal processing path;
said polyphase determination circuit having a phase accumulator of finite word length followed by a phase decoder for driving said interpolator and supplying said interpolator with polyphases p(n).

2. The signal processor according to claim 1, which further comprises a uniform interface for transferring the transmit signals to modules for converting low-pass signals to carrier frequency.

3. The signal processor according to claim 2, wherein said uniform interface contains two analog or digital signals in the form of a normal component and a quadrature component or amplitude component and phase component.

4. The signal processor according to claim 1, wherein said clock frequency generator and other signal processing circuits are commonly integrated on a common chip.

5. The signal processor according to claim 1, wherein said clock frequency generator, said interpolator circuit configuration, said linear asynchronous polyphase interpolator, and said polyphase determination circuit are commonly integrated on a common chip.

6. A method for digitally generating mobile communication transmit signals compatible with a plurality of different mobile radio standards, which comprises:
generating a common system-independent clock frequency in transmitting mode for each mobile radio standard for at least one of signal processing and D/A conversion of the transmit signals;
performing an interpolation in each signal processing path of a mobile radio standard, for converting the transmit signals to a uniform timing pattern;
processing the signals with a linear asynchronous polyphase interpolator and a polyphase determination circuit in at least one signal processing path, wherein
the polyphase determination circuit has a phase accumulator of finite word length followed by a phase decoder, and the phase decoder drives the interpolator and supplies the interpolator with the polyphases p(n).

7. The method according to claim 6, which comprises transferring the transmit signals with a uniform interface to the modules for converting the low-pass signal to the carrier frequency.

8. The method according to claim 6, which comprises processing mobile radio standards selected from the group consisting of GSM, EDGE, TIA/EIA-136, and mixed forms and partial combinations thereof.

9. The method according to claim 6, which comprises jointly utilizing, for a number of the mobile radio standards, various circuit components in the signal processing path.

10. The method according to claim 9, which comprises jointly utilizing circuit components for pulse shaping, sampling rate conversion, noise shaping, phase and frequency correction, and phase and amplitude error correction of the normal components and the quadrature components.
